(19) United States
(12) Patent Application Publication
(10) Pub. No.: US 2006/0233157 A1
(43) Pub. Date: Oct. 19, 2006

(54) System and method of voice transmission to mobile data networks

(76) Inventor: Zheng John Shi, Tiburon, CA (US)

Correspondence Address: ZHENG J. SHI, 336 BLACKFIELD DRIVE, TIBURON, CA, 94920, US

(21) Appl. No.: 11/108,091

(22) Filed: Apr. 18, 2005

(51) Int. Cl. H04L 12/66; H04J 3/16

(52) U.S. Cl. 370/352; 370/466

(57) ABSTRACT

The present invention permits the real-time voice input of a mobile phone handset to be sent to a networked device via mobile data networks, without the involvement of broadband wireless networks such as Bluetooth, WI-FI or WIMAX. Currently, much work has been done to enable VoIP communication via the WI-FI protocol. WI-FI access requires the mobile handset supporting WI-FI feature, and the presence of WI-FI gateway, typically installed in hot spots such as airport or coffee shops. This is not ideal as the combination of these two criteria means that only a small fraction of the handsets that support WI-FI can make such VoIP calls and only when the users are within a hot spot. The present invention eliminates these limitations and enables voices to be transmitted to the mobile data network directly, whenever and wherever there is mobile phone dial tone.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The present invention relates generally to transmitting voice over mobile data networks, and more particularly, to a system and method of transmitting voice from a mobile phone to a networked device via a mobile data network.

2. Description of the Related Art

Generally speaking, voice is transmitted from one mobile phone to another, via the voice channel of mobile phone networks. These voice networks have been built over time and are primarily dedicated for transmitting voice only.

With the advent of new technologies and new networks such as the Internet and the wireless Internet it has become possible for the mobile phone to connect to the Internet directly, for example, if the mobile phone supports WI-FI and if the Internet access is available via a WI-FI (Wireless Fidelity) gateway. The major advantages of such voice transmission via the Internet and WI-FI are:
1. Low cost. Dedicated voice channels and networks have required very large investments to be made over the years to build. So there are few network operators to choose from and cost is high. With WI-FI and the Internet, voice communication networks can be built overnight with the existing WI-FI and Internet infrastructure and at much lower cost. From a consumer standpoint, wireless voice communications via WI-FI would eliminate the need to pay high prices to wireless voice communication service providers and allow customer to choose from may more providers.
2. Value-added services. Once the voice communication has become digitized and is transmitted via the data networks, other value-added services can be easily built on top of the voice communications, such as voice recording, indexing, searching, and sharing, and exchanges of files of any format together with the voice communications.
   One disadvantage of utilizing technologies such as WI-FI to implement VoIP for mobile telephony is that it requires the mobile phone to support such WI-FI feature. At the present moment, the vast majority of mobile phones do not have features to support WI-FI. Another disadvantage of utilizing WI-FI to implement VoIP for mobile telephony is that it requires the presence of a WI-FI gateway to connect that mobile handset to the Internet. While WI-FI gateways have sprung up across the US and much of the developed worlds such as South Korea and the Nordic countries, in the so-called “hot spots” such as hotels, coffee shops and airports, they are the exceptions rather than the rules. Most of the time the users of a mobile phone will find themselves not within a hot spot. Thus, VoIP with the WI-FI method does not appear to be able to meet the needs of most mobile users most of the time.

From the discussion above, it should be apparent that there is a need for better method of transmitting voice from a mobile phone to a networked server, specifically, a method that captures voice from the mobile phone handset and transmit it via a wireless data network rather than the traditional voice communication networks. The present invention fulfills this need.

### BRIEF SUMMARY OF THE INVENTION

The present invention permits the transmitting of voice to a networked device via a mobile data network, from a mobile phone handset, such as a Nokia 7610 handset running the Symbian operating system, in the form of a data file, without the voice or the data file having to go through the voice channel of telephone networks.

Other features and advantages of the present invention should be apparent and will be better understood by reference to the drawings and the following detailed description, which illustrate, by way of example, the principles of the invention.

### DETAILED DESCRIPTION OF THE INVENTION

The present invention outlines a system and provides several implementations for transmitting voice into a mobile data network, without having to go through the voice channel of traditional phone networks and without having to use WI-FI to access the Internet. It is a system that allows voice to be transmitted to a networked server at any time and anywhere there is mobile data network coverage, such as GPRS or CDMA.

System Configuration

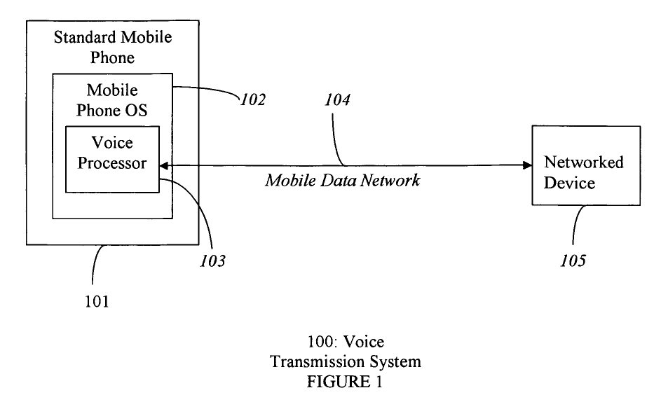

FIG. 1 shows a system 100 consisting of a mobile phone handset 101, running an advanced mobile phone operating system 102, voice processor 103 runs on top of the mobile operating system 102, a mobile data network connection 104, and a networked device 105. The mobile phone handset receives the voice of a person, pass the voice signal to the mobile phone operating system, which passes the voice signal to the voice processor, which converts the voice into digital format and sends it across the mobile data network connection to a networked device.

System Implementation

Embedded in the hardware of a mobile phone is the capability to convert the voice from a person to into a digital form; such digitized form of voice can then be intercepted by the voice processor, with standard Application Programmable Interfaces (APIs) provided by an advanced mobile phone operating system.

Because of the fact that currently the Symbian operating system has a high market share among all advanced operating systems, we will use it as an example to implement our system and method. Similar implementation can be achieved with other advanced mobile phone operating systems such as those from Microsoft and Palm.

First, we will establish a data file of 1 kilobyte in size, and make it the buffer of the data transmissions.

```
Function CreateFileBuf(filename)
{
    _LIT(KFilename,filename);
    RFile file;
    file.Create(theFs,KFilename,EFileWrite| EfileWrite| EFileStream);
    file.SetSize(1024);
    file.Open(theFs,fileName, EFileWrite| EfileWrite| EFileStream);
}
```

Then, create an object iMdaAudioRecorderUtility to instantiate a class—CmdaAudioRecorderUtility—, that records the voice, converts it to digital information and writes it into the data file:

Function RecordVoiceToFile(filename)
{
_LIT(KFilename,filename);
iMdaAudioRecorderUtility->OpenDesL(KFilename);
iMdaAudioRecorderUtility->SetAudioDeviceMode(
CMdaAudioRecorderUtility::ELocal );
iMdaAudioRecorderUtility->SetGain( iMdaAudioRecorderUtility->
MaxGain( ) );
iMdaAudioRecorderUtility->SetDestinationBitRateL( );
iMdaAudioRecorderUtility->SetDestinationSampleRateL( );
iMdaAudioRecorderUtility->SetPosition(
TTimeIntervalMicroSeconds( 0 ) );
iMdaAudioRecorderUtility->CropL( );
iMdaAudioRecorderUtility->RecordL( );
}

Then, send the data file to a networked device, such as a server. Typically a networked device would possess an IP address in the format of 4 groups of numbers, x, y, z, w, where each group has up to 3 digits, for example 256.23.456. 1. The data file is sent to such networked device through a socket connection. Below illustrates how this is done with the Symbian operating system. First, create a socket:

```
Function CreateSocket( )
{
    RSocketServ socketserv;
    RSocket socket;
    //connect to the socket server
    Socketserv.Connect( );
    //open a tcp socket;
    socket.Open(socketserv, KAfInet, KSockStream, KProtocolInetTcp);
}
```

Then, send the data file. The data file is initially stored in a buffer, then send to the networked device with the TCP protocol and the “connect” function:

```
Function SendData( )
{
    _LIT(kNetDeviceIp,”x.y.z.w”);
    const TInt kPort = DefinePort;
    TInetAddr destAddr;
    destAddr.Input(kNetDeviceIp);
    destAddr.SetPort(kPort);
    // Request the Socket to connect to the networked device.
    sock.Connect(destAddr, status);
    //read datafile
    _LIT(KFilename,filename);
    RFile file;
    file.read(buf, 1024);
    //send to networded device
    sock.Write(buf,status);
}
```

After such transmission the socket connection is closed.

We claim:

1. A method for transmitting voice from a mobile phone to a networked device, the method comprising:
receiving, a voice signal from a user of a mobile phone that runs an advanced operating system;
converting, the said voice signal into digitized format; and
sending, to a networked device, the said digitized voice signal,
wherein the sending action is accomplished via a mobile data network, without involving BlueTooth, WI-FI or WIMAX technologies.

2. A method as defined in claim 1, wherein the said mobile data network is based on GPRS.

3. A method as defined in claim 1, wherein the said mobile data network is based on CDMA.

4. A method as defined in claim 1, wherein the said mobile data network is based on EDGE.

5. A method as defined in claim 1, wherein the said mobile data network is based on CDMA2000.

6. A method as defined in claim 1, wherein the said mobile data network is based on TD-SCDMA.

7. A method as defined in claim 1, wherein the said mobile data network is based on WCDMA.

8. A method as defined in claim 2, 3, 4, 5, 6 and 7, wherein the said advanced operating system is the Symbian mobile phone operating system.

9. A method as defined in claim 2, 3, 4, 5, 6 and 7, wherein the said advanced operating system is the Microsoft mobile phone operating system.

10. A method as defined in claim 2, 3, 4, 5, 6 and 7, wherein the said advanced operating system is the Palm mobile phone operating system.

11. A method as defined in claim 2, 3, 4, 5, 6 and 7, wherein the said advanced operating system is the Embedded Linux mobile phone operating system.

12. A method as defined in claim 2, 3, 4, 5, 6 and 7, wherein the said advanced operating system is other Graphical User Interface (GUI) based mobile phone operating systems.

13. A method as defined in claim 8, 9, 10, 11 and 12, wherein the said networked device is a mobile phone.

13. A method as defined in claim 8, 9, 10, 11 and 12, wherein the said networked device is a computer.
